(19) United States
(12) Patent Application Publication
(10) Pub. No.: US 2005/0132027 A1
(43) Pub. Date: Jun. 16, 2005

(54) Method, apparatus and system for formal planning and implementation of network strategies and architecture

(76) Inventors: John B. Vicente, Roseville, CA (US); Don G. Meyers, Rescue, CA (US); Chedley Aouriri, Beaverton, OR (US); Hong Li, El Dorado Hills, CA (US); Grant D. Fraser, Auburn, CA (US); Shelby Siegel, Piedmont, CA (US)

Correspondence Address: INTEL CORPORATION, P.O. BOX 5326, SANTA CLARA, CA, 95056-5326, US

(21) Appl. No.: 10/738,840

(22) Filed: Dec. 16, 2003

(51) Int. Cl. G06F 15/177

(52) U.S. Cl. 709/220

(57) ABSTRACT

A method and system for formal planning and implementation of network strategies and architectures is disclosed. More specifically, according to an embodiment of the present invention, network services may be conceptually divided into a framework comprising vertical resources and services and horizontal resources and services. This framework may be used to determine a network's existing capabilities as well as to plan for the network's expansion and evolution. According to one embodiment, the vertical resources and services may comprise transport services capability architecture, virtual network capability architecture, security capability service architecture and quality of service architecture. The horizontal resources and services may include IP layered services architecture, core network services architecture and core network transport architecture.

### FIELD

The present invention relates to the field of network systems management and, more particularly to a method, apparatus and system for formal planning and implementation of network strategies and architecture.

### BACKGROUND

Information technology (“IT”) networks in large corporations today are becoming increasingly complex. As these corporations grow and technology advances, the tasks of planning and/or architecting these networks are becoming exponentially more difficult. Existing network architectural models such as Asynchronous Transfer Mode (“ATM”), Transport Control Protocol/Internet Protocol (“TCP/IP”), Signaling Systems 7 (“SS7”) and 3^{rd} Generation Wireless (“3G”) are structured specific to their technology framework and supporting network services, and as a result, these architectural models do not comprehend the complexities of IT network environments. Other networking models such as the Open Systems Interconnect (“OSI”) model similarly do not address architectural service and resource integration and evolution and/or migrating capabilities across alternative architectural stacks and/or network domains.

### BRIEF DESCRIPTION OF THE DRAWINGS

The present invention is illustrated by way of example and not limitation in the figures of the accompanying drawings in which like references indicate similar elements, and in which:

FIG. 1 illustrates a conceptual overview of an embodiment of the present invention;

FIG. 2 is a flow chart illustrating in further detail how the framework in FIG. 1 may be utilized to plan a network strategy and/or architecture;

FIG. 3 illustrates an example of a roadmap that may be generated by an embodiment of the present invention; and

FIG. 4 is a flow chart illustrating the process of generating a roadmap according to an embodiment of the present invention.

### DETAILED DESCRIPTION

Embodiments of the present invention provide an integration framework for formal planning and implementation of network strategies and architecture. More specifically, an embodiment of the present invention discloses a method, apparatus and system that enable IT organizations to evaluate and implement network requirements using a taxonomy-oriented representation of network technology and/or service architecture. Reference herein to “IT organizations” shall not be limited to such and may include any entity planning and/or implementing network strategies and/or architectures. Additionally, reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

As previously described, the task of planning and/or architecting large, complex networks is becoming exponentially more difficult. Currently, in order to evolve a network's capabilities and/or resources, IT organizations are likely forced to make ad-hoc determinations. When dealing with large, complex networks, the task of determining all the necessary resources and/or capabilities, and a plan for implementing the same is daunting, at best. At worst, the lack of a formal process for making such determinations leaves open room for significant margins of error and/or inefficiencies. Thus, for example, the IT organization may determine that the corporation is in need of more robust firewall services to enhance security, but has no standard methodology by which it may determine how these new services may be transitioned and/or integrated with the existing security features on the corporation's global and heterogeneous networks.

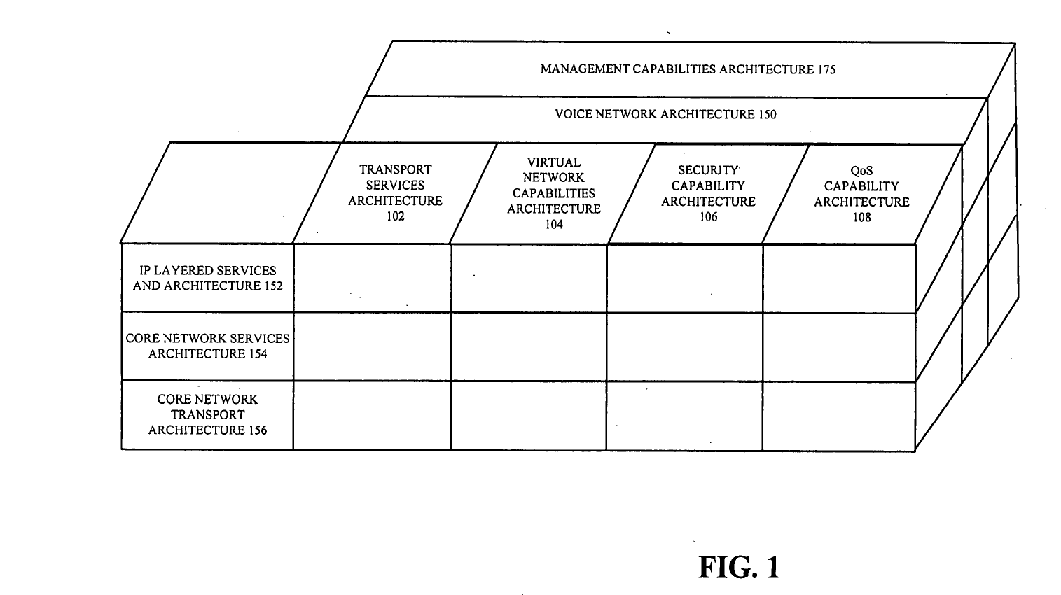

Embodiments of the present invention provide a conceptual representation of network technology and service architecture from which a cohesive IT network strategy and/or roadmap may be developed. Although described herein as being specific to IT environments, embodiments of the present invention are not so limited and may be beneficial in any complex, heterogeneous network environment. According to embodiments of the present invention, IT organizations may utilize a taxonomy-oriented representation of a network's resources and capabilities to plan and implement new network strategies and/or architectures. FIG. 1 illustrates a conceptual overview of an embodiment of the present invention. As illustrated, a network's capabilities are divided into a taxonomy-oriented representation of the network, namely a framework of “vertical capability services” (referred to hereafter as “Network Capability Services Architecture 100”) and “horizontal capability services” (referred to hereafter as “Network Transport and Communication Services Architecture 150”). The network may include Frame Relay networks, ATM networks, IP/Ethernet-based networks, 802.11a/b and/or 2.5/3G technologies and systems, but embodiments of the invention are not limited by current network architectures and/or network service implementations.

In one embodiment of the present invention, Network Capability Services Architecture 100 represents the fundamental services supported by a communication system. Overall, Network Capability Services Architecture 100 may provide reactive and proactive network management and network control services used to manage and/or provision transport, Quality of Service (“QoS”), virtual networks and security capabilities. This component may be viewed as a logically separate entity in the framework, and may be further broken down into its subcomponent services. These subcomponent services are represented in FIG. 1 as Transport Services Capability Architecture 102, Virtual Network Capability Architecture 104, Security Capability Service Architecture 106 and Quality of Service Architecture 108.

Transport Services Capability Architecture 102 includes essential communications services to support basic, best-effort communications while Virtual Network Capability Architecture 104 includes the ability to create logical divisions of the physical network to enable the partitioning, isolation and connectivity for various applications. Similarly, Security Capability Service Architecture 106 includes protection and privacy capabilities to enable confidentiality, integrity, and availability of networks and Quality of Service Architecture 108 includes the underlying network services and/or device mechanisms to enable service differentiation, traffic engineering and bandwidth management.

According to an embodiment, Network Transport and Communication Services Architecture 150 may include three architectural layers, representing i.) physical transport and link access; ii.) low-level IP services for enhancing the core transport; and iii.) high-level services providing additional basic and enhanced services over the core physical and logical transport. In one embodiment, these layers may be deployed as separate overlay network architectures in various implementation forms including peer networks, hierarchical virtual networks, and/or edge-based network architecture implementation schemes. These architectural layers are illustrated in FIG. 1 as Core Network Transport Architecture 156, Core Network Services Architecture 154 and IP Layered Services Architecture 152.

Core Network Transport Architecture 156 may include wired and/or wireless means for geographically dispersed corporate sites to remotely communicate via a network such as a Metropolitan Area Network (MAN) and/or Wide Area Network (WAN). Core Network Transport Architecture 156 may additionally provide local network connectivity (wired and/or wireless) within a corporate site. Core Network Services Architecture 154 includes the fundamental network services from which layered services are built to support current and next-generation computing and networking. Finally, IP Layered Services Architecture 152 may include a set of common infrastructure services to provide standardized capabilities for data, voice/telephony and multimedia applications.

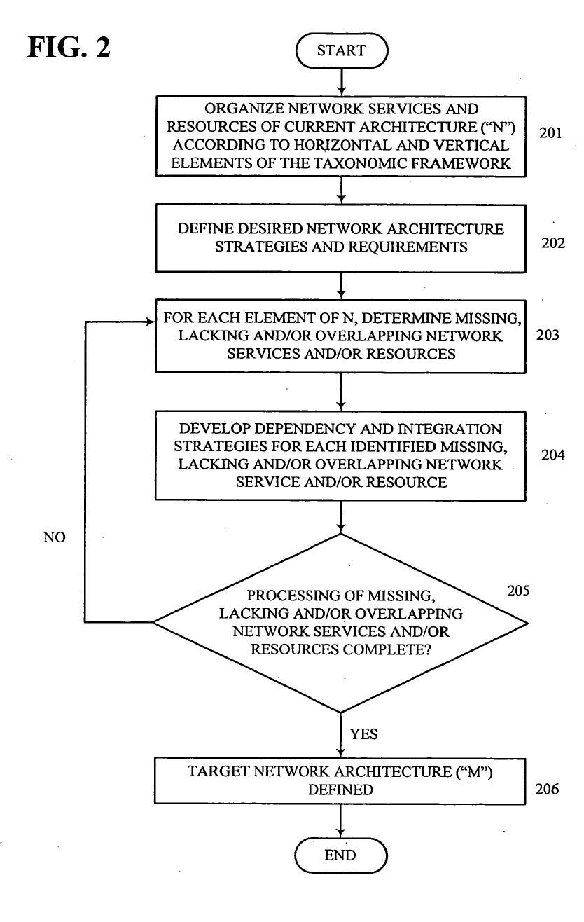

FIG. 2 is a flow chart illustrating in further detail how the framework in FIG. 1 may be utilized to plan a network strategy and/or architecture. Although the following operations may be described as a sequential process, many of the operations may in fact be performed in parallel and/or concurrently. In addition, the order of the operations may be re-arranged without departing from the spirit of embodiments of the invention. In 201, the network services and resources of a current network architecture (“Baseline Network Architecture N” currently, i.e., at time T=0) may be organized according to the horizontal and vertical elements of the taxonomic framework. Additionally, in 202, the desired target network architecture strategies and requirements (“Target Network Architecture M”) may be defined. For each element of Baseline Network Architecture N, missing, lacking and/or overlapping network services and/or resources may be identified in 203. In 204, based on the identified services and/or resources, and based on Target Network Architecture M, dependency and integration strategies may be developed. This process may continue until all elements of Baseline Network Architecture N are processed in 205 and Target Network Architecture M is defined in 206.

In one embodiment, Target Network Architecture M represents the new network strategy and/or architecture that the IT organization is trying to achieve. As described above, the details of the strategy and/or architecture are not determined in an ad-hoc manner, as is typically done currently. Instead, according to an embodiment of the present invention, given the taxonomy-oriented representation of the network, the missing, lacking and/or overlapping resources and capabilities in the network may be easily identified. Additionally, the same framework may be utilized to develop strategic plans and/or new network architectures for other networks. It will be readily apparent to those of ordinary skill in the art that although various types of networks may include different resources and/or capabilities, the elements described in FIG. 1 above exist in almost all complex networks. Thus, for example, FIG. 1 may be also applicable to voice network architecture (illustrated in FIG. 1 as “Voice Network Architecture 150”) and/or management capabilities architecture (illustrated in FIG. 1 as “Management Capabilities Architecture 175”).

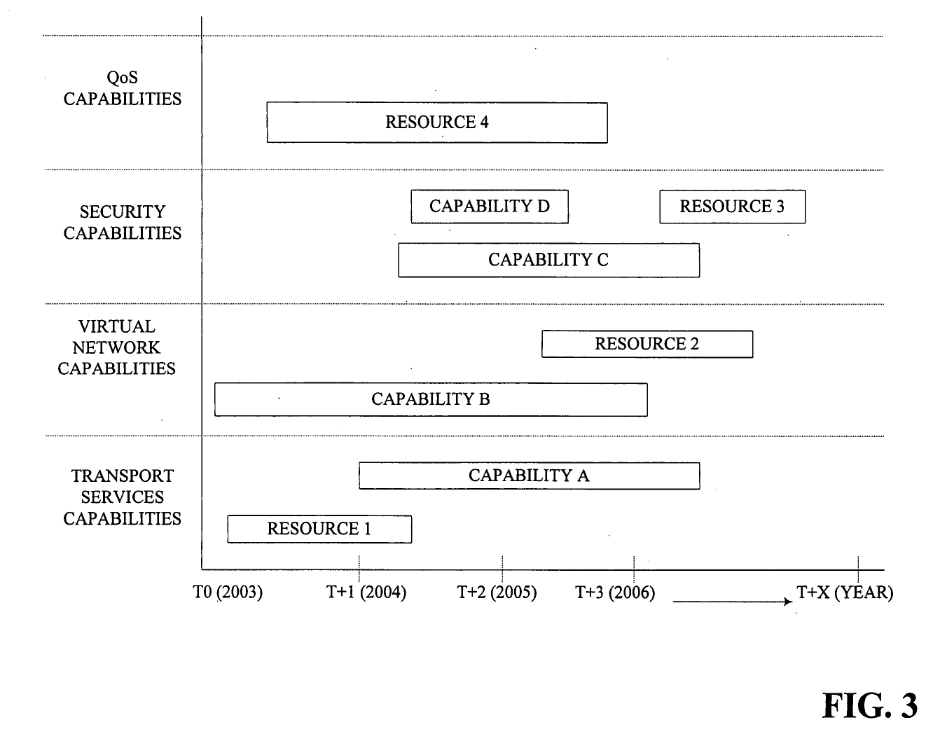

Upon identifying Target Network Architecture M, an IT organization may additionally utilize embodiments of the present invention to determine an appropriate implementation strategy and/or roadmap. FIG. 3 illustrates an example of a roadmap (“Roadmap 300”) that may be generated by an embodiment of the present invention. Roadmap 300 may include detailed timelines of network evolution based on resource and/or capabilities available at different points in time (illustrated as times T=0 to T=X). Thus, for example, as illustrated, if the process described in FIG. 2 above identifies Resources 1-4 and Capabilities A-D as desired resources and capabilities in Target Network Architecture M, Roadmap 300 may include a detailed timeline of how and/or when Resources 1-4 and Capabilities A-D may be available and/or implemented.

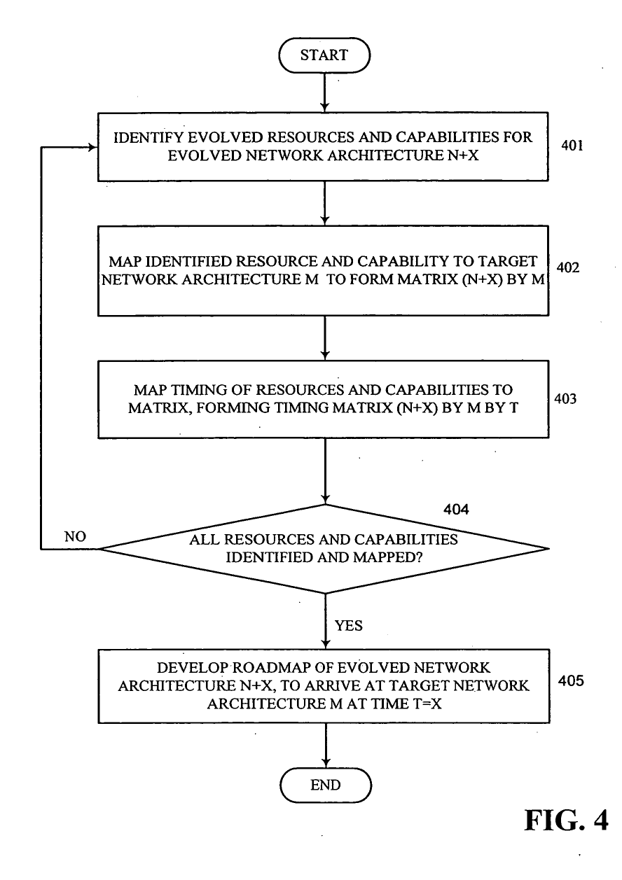

FIG. 4 is a flow chart illustrating the process of generating a roadmap according to an embodiment of the present invention. Again, although the following operations may be described as a sequential process, many of the operations may in fact be performed in parallel and/or concurrently. In addition, the order of the operations may be re-arranged without departing from the spirit of embodiments of the invention. In 401, the evolving network services and/or resources (“Evolved Network Architecture N+X, representing evolved Baseline Network Architecture N at various times T=1 to T+=X) may be identified within the framework of FIG. 1. In 402, the network services and/or resources of Evolved Network Architecture N+X may be mapped to elements of Target Network Architecture M, forming a matrix of components (N+X by M). The timing or availability of resources and/or services may then be mapped to the identified components in the matrix in 403, thus generating a three-dimensional timing matrix (N+X by M by T). The process may continue in 404 until each component is identified and mapped to the three-dimensional matrix. In 405, based on the three-dimensional timing matrix, a roadmap of Evolved Network Architecture N+X may be developed (i.e., Evolved Network Architecture N+1 at time T=1, Evolved Network Architecture N+2 at time T=2, etc.), to arrive at Target Network Architecture M at time T=X.

The networks according to embodiments of the present invention may include a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the computing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of planning resources and services of a network architecture, comprising:
defining existing vertical network resources and services;
defining existing horizontal network resources and services, the existing vertical network resources and services and existing horizontal network resources and services creating a current taxonomy-oriented representation of the network;
identifying at least one of desired vertical network resources and services and horizontal network resources and services from the current taxonomy-oriented representation of the network; and
defining a desired target network based on the existing taxonomy-oriented representation of the network and the at least one of the desired vertical network resources and services and horizontal network resources and services.

2. The method according to claim 1 wherein the existing vertical network resources and services and the desired vertical network resources and services include at least one of transport capability, virtual nets capability, security capability and quality of service (“QoS) capability.

3. The method according to claim 1 wherein the existing horizontal network resources and services and the desired horizontal network resources and services include at least one of internet protocol (“IP”) layered services, core network services and core network transport services.

4. The method according to claim 1 wherein defining the desired target network further comprises defining a dependency and integration strategy for the desired target network based on the existing vertical resources and services, the existing horizontal resources and services, the desired vertical resources and services and the desired horizontal resources and services.

5. The method according to claim 4 further comprising:
identifying evolved vertical network resources and services representing the desired vertical network services at predetermined time intervals;
identifying evolved horizontal network resources and services representing the desired horizontal network resources and services at the predetermined time intervals;
mapping the evolved vertical network resources and services and evolved horizontal network resources and services to a matrix including the predetermined time intervals; and
generating a roadmap for implementing the desired target network.

6. The method according to claim 5 wherein mapping the evolved vertical network resources and services and evolved horizontal network resources and services to the matrix further includes generating a timing matrix identifying availability of evolved vertical network resources and services and evolved horizontal network resources and services at the predetermined time intervals.

7. The method according to claim 6 wherein generating the roadmap includes translating the timing matrix into a timeline for implementing the desired target network,

8. A method of planning resources and services on a network, comprising:
defining resources and services in a vertical plane;
defining resources and services in a horizontal plane, the vertical plane and horizontal plane comprising a resource and service framework; and
utilizing the resource and services framework to identify existing network resources and services and desired network resources and services in the vertical plane and the horizontal plane.

9. The method according to claim 8 wherein utilizing the resource and service framework further comprises determining the desired resources and services in the vertical plane and in the horizontal plane.

10. The method according to claim 8 wherein the existing resources and services in the vertical plane and the desired resources in and services the vertical plane include at least one of transport capability, virtual nets capability, security capability and quality of service (“QoS) capability.

11. The method according to claim 8 wherein the existing resources and services in the horizontal plane and the desired resources and services in the horizontal plane include at least one of internet protocol (“IP”) layered services, core network services and core network transport.

12. A resource framework for formal planning and implementation of network strategy and architecture, comprising:
a plurality of resources and services in a vertical plane; and
a plurality of resources and services in a horizontal plane, the plurality of resources and services in the vertical plane and in the horizontal plane comprising the resource framework, the resource framework enabling identification of existing network resources and services and desired network resources and services in the vertical plane and the horizontal plane.

13. The resource framework according to claim 12 wherein the plurality of resources on the vertical plane include at least one of transport capability, virtual nets capability, security capability and quality of service (“QoS) capability.

14. The resource framework according to claim 12 wherein the plurality of resources on the horizontal plane include at least one of internet protocol (“IP”) layered services, core network services and core network transport.

15. An article comprising a machine-accessible medium having stored thereon instructions that, when executed by a machine, cause the machine to:
define existing vertical network resources and services;
define existing horizontal network resources and services, the existing vertical network resources and services and existing horizontal network resources and services creating a current taxonomy-oriented representation of the network;
identify at least one of desired vertical network resources and services and horizontal network resources and services from the current taxonomy-oriented representation of the network; and
define a desired target network based on the existing taxonomy-oriented representation of the network and the at least one of the desired vertical network resources and services and horizontal network resources and services.

16. The article according to claim 15 wherein the existing vertical network resources and services and the desired vertical network resources and services include at least one of transport capability, virtual nets capability, security capability and quality of service (“QoS) capability.

17. The article according to claim 16 wherein the existing horizontal network resources and services and the desired horizontal network resources and services include at least one of internet protocol (“IP”) layered services, core network services and core network transport services.

18. The article according to claim 16 wherein the instructions, when executed by the machine, further cause the machine to define a dependency and integration strategy for the desired target network based on the existing vertical resources and services, the existing horizontal resources and services, the desired vertical resources and services and the desired horizontal resources and services.

19. The article according to claim 16 wherein the instructions, when executed by the machine, further cause the machine to:
identify evolved vertical network resources and services representing the desired vertical network services at predetermined time intervals;
identify evolved horizontal network resources and services representing the desired horizontal network resources and services at the predetermined time intervals;
map the evolved vertical network resources and services and evolved horizontal network resources and services to a matrix including the predetermined time intervals; and
generate a roadmap for implementing the desired target network.

20. The article according to claim 19 wherein the instructions, when executed by the machine, further cause the machine to generate a timing matrix identifying availability of evolved vertical network resources and services and evolved horizontal network resources and services at the predetermined time intervals.

21. The article according to claim 20 wherein the instructions, when executed by the machine, further cause the machine to translate the timing matrix into a timeline for implementing the desired target network,

22. An article comprising a machine-accessible medium having stored thereon instructions that, when executed by a machine, cause the machine to:
define resources and services in a vertical plane;
define resources and services in a horizontal plane, the vertical plane and horizontal plane comprising a resource and service framework; and
utilize the resource and services framework to identify existing network resources and services and desired network resources and services in the vertical plane and the horizontal plane.

23. The article according to claim 22 wherein the instructions, when executed by the machine, further cause the machine to determine the desired resources and services in the vertical plane and in the horizontal plane.

24. The article according to claim 22 wherein the existing resources and services in the vertical plane and the desired resources in and services the vertical plane include at least one of transport capability, virtual nets capability, security capability and quality of service (“QoS) capability.

25. The article according to claim 22 wherein the existing resources and services in the horizontal plane and the desired resources and services in the horizontal plane include at least one of internet protocol (“IP”) layered services, core network services and core network transport.
